(19) United States
(12) Patent Application Publication
(10) Pub. No.: US 2007/0249754 A1
(43) Pub. Date: Oct. 25, 2007

(54) Methods of modifying polyurethanes using surface treated clay

(75) Inventors: SuPing Lyu, Maple Grove, MN (US); Thomas P. Grailer, Ramsey, MN (US); James Louis Schley, Coon Rapids, MN (US); Christopher M. Hobot, Tonka Bay, MN (US); Christopher A. Deegan, North St. Paul, MN (US); Randall V. Sparer, Andover, MN (US)

Correspondence Address: MUETING, RAASCH & GEBHARDT, P.A., P.O. BOX 581415, MINNEAPOLIS, MN, 55458, US

(73) Assignee: Medtronic, Inc., Minneapolis, MN (US)

(21) Appl. No.: 11/789,131

(22) Filed: Apr. 24, 2007

Related U.S. Application Data
(60) Provisional application No. 60/794,760, filed on Apr. 25, 2006.

(51) Int. Cl. C08K 9/00; C08K 9/04

(52) U.S. Cl. 523/200; 524/445

(57) ABSTRACT

Methods of modifying polyurethanes using surface treated clay are disclosed herein. Such methods can be useful for controlling the surface concentration of one or more additives in the polyurethane, which can be useful for fabricating medical devices therefrom.

This application claims the benefit of U.S. Provisional Application No. 60/794,760, filed 25 Apr. 2006, which is hereby incorporated by reference in its entirety.

### BACKGROUND

Polyurethanes have useful properties for making medical devices. For example, thermoplastic polyurethanes such as aromatic polyether-based polyurethanes are generally characterized as having a balance of properties including abrasion resistance, low temperature flexibility, solvent resistance, biocompatibility, biostability, hydrolytic stability, electrical properties, and mechanical properties that make them attractive for fabricating medical devices. Some medical devices further require specific properties including, for example, adhesion to silicone adhesives. However, adhering a polyurethane to a silicone adhesive typically requires the time consuming process of cleaning the polyurethane surface in order to result in adequate adhesion on a consistent basis.

Thus, polyurethanes that can be readily adhered to a silicone adhesive are sought in the art.

### SUMMARY

Additives are frequently added to polyurethanes for a wide variety of reasons including, for example, to improve processing, modify physical and/or chemical properties, modify surface properties, and/or stabilize the polymer to heat and/or light. Some of these additives have been found to migrate or accumulate on the surface of the polymer, which can be advantageous for some properties, and deleterious for others. The present invention surprisingly has provided a method for controlling the surface concentration of at least some of the additives described herein.

In one aspect, the present invention provides a method of controlling the surface concentration of an additive in a polyurethane. The method includes: providing a polyurethane including an additive; and combining a surface treated clay with the polyurethane, wherein the surface of the clay includes an ammonium cation of the formula: R¹R²R³R⁴N⁺ wherein each R group independently represents hydrogen or a hydrocarbon moiety.

In another aspect, the present invention provides a method of preparing a polyurethane for a medical device. The method includes: providing a polyurethane including an additive; and dispersing a surface treated clay in the polyurethane, wherein the surface of the clay includes an ammonium cation of the formula: R¹R²R³R⁴N⁺ wherein each R group independently represents hydrogen or a hydrocarbon moiety.

Surprisingly, certain polyurethane composites including a surface treated clay as described herein have been found to offer adequate adhesion to silicone adhesives without the need for the traditional surface cleaning process. The potential elimination of such a time consuming cleaning process can have advantageous applications including, for example, the fabrication of medical devices.

### Definitions

As used herein, a “medical device” may be defined as a device that has surfaces that contact tissue, bone, blood or other bodily fluids in the course of their operation, which fluids are subsequently used in patients. This can include, for example, extracorporeal devices for use in surgery such as blood oxygenators, blood pumps, blood sensors, tubing used to carry blood and the like which contact blood which is then returned to the patient. This can also include endoprostheses implanted in blood contact in a human or animal body such as vascular grafts, stents, pacemaker leads, heart valves, and the like, that are implanted in blood vessels or in the heart. This can also include devices for temporary intravascular use such as catheters, guide wires, and the like which are placed into the blood vessels or the heart for purposes of monitoring or repair.

As used herein, “composite” refers to a polymeric material having one or more than one filler therein. The filler can be a particulate, fiber, or platelet material. Preferably, the filler is dispersed in the polymeric material.

As used herein, “nanoclay” means a clay having at least one dimension of less than 100 nanometers (e.g., montmorillonite clay). Typically, nanoclay has a plate-like structure in which the thickness of the plates is less than 10 nanometers.

As used herein, hydrogenated tallow refers to a hydrogenated fat typically from the fatty tissue of animals (e.g., CAS No. 8030-12-4). Hydrogenated tallow is generally a mixture of, but not limited to, C14-C18 hydrocarbons.

The terms “comprises” and variations thereof do not have a limiting meaning where these terms appear in the description and claims.

As used herein, “a,” “an,” “the,” “at least one,” and “one or more” are used interchangeably.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a graphical representation of percent carbon (atomic) measured by XPS as described in Example 1 on surfaces including bulk N,N′-ethylenebisstearamide (EBS), polyurethane samples measured without and with surface cleaning (Normal PU and Cleaned PU, respectively), and samples of polyurethane composites having 2 wt-% clay for composites prepared using untreated (NA) and various treated montmorillonite clays (e.g., 30B, 10A, 25A, 93A, and 15A, available under the trade designation CLOISITE from Southern Clay Products, Inc., Gonzales, Tex.). The error bars in the figure indicate the standard deviation of 2 to 4 repeats.

FIG. 2 is a graphical representation of percent carbon (atomic) measured by XPS as described in Example 2 on surfaces of an unfilled polyurethane sample (0 wt-%) and polyurethane composites having 0.5, 1, 2, and 3.5 wt-% CLOISITE 10A clay that were annealed at 60° C. for 4 hours (□) and 21 days (▪). The error bars in the figure indicate the standard deviation of 2 to 4 repeats.

FIG. 3 is a graphical representation of the peel force measured as described in Example 3 illustrating adhesion of a silicone medical adhesive (available under the trade designation MED 2000 from Nusil Technology, Carpinteria, Calif. (Lot 34896)) with polyurethane samples used without and with surface cleaning (Normal PU and Pure PU, respectively), and samples of polyurethane composites having 2 wt-% clay for composites prepared using untreated (NA) and various treated montmorillonite clays (e.g., 30B, 10A, 25A, 93A, available under the trade designation CLOISITE from Southern Clay Products, Inc., Gonzales, Tex.). The error bars in the figure indicate the standard deviation of 4 repeats.

FIG. 4 is a graphical representation of the peel force measured as described in Example 3 illustrating adhesion of a silicone medical adhesive (available under the trade designation MED 2000 (Lot number: 34896) from Nusil Technology, Carpinteria, Calif.) with polyurethane samples that were filled with and without clay fillers and had varying percent carbon (atomic) surface content as measured by XPS (same samples as those in FIGS. 1 to 3). The error bars in the figure indicate the standard deviation of 4 repeats.

FIG. 5 is a graphical representation of the water contact angle measured as described in Example 4 for polyurethane samples having varying percent carbon (atomic) surface content as measured by XPS. The samples used here were the polyurethane filled with and without CLOISITE 10A followed by 21 days of annealing. The data were the average of 5 repeats.

### DETAILED DESCRIPTION OF ILLUSTRATIVE EMBODIMENTS

In one aspect, the present invention provides a method of controlling the surface concentration of an additive in a polyurethane. The method includes: providing a polyurethane including an additive; and combining a surface treated clay with the polyurethane, wherein the surface of the clay includes an ammonium cation of the formula: R¹R²R³R⁴N⁺ wherein each R group independently represents hydrogen or a hydrocarbon moiety.

In another aspect, the present invention provides a method of preparing a polyurethane for a medical device. The method includes: providing a polyurethane including an additive; and dispersing a surface treated clay in the polyurethane, wherein the surface of the clay includes an ammonium cation of the formula: R¹R²R³R⁴N⁺ wherein each R group independently represents hydrogen or a hydrocarbon moiety.

The presently disclosed composites include aromatic polyether-based polyurethanes that are preferably thermoplastic polyurethanes (TPUs). Thermoplastic polyurethanes have hard and soft segments that lead to desirable mechanical properties. Medical grade polyurethanes typically offer biocompatibility properties, biostability properties, mechanical properties, electrical properties, and/or purity that makes the polyurethane suitable to fabricate medical devices. Medical grade aromatic polyether-based polyurethanes are generally prepared by reacting aromatic isocyanates (e.g., methylene diphenyl diisocyanate, MDI) with one or more polyols. Preferred polyols include, for example, polyether glycols (e.g., polytetramethylene ether glycol, PTMEG) and a chain extender such as, for example, 1,4-butanediol.

Exemplary medical grade aromatic polyether-based polyurethanes include, for example: those available under the trade designation PELLETHANE available from Dow Plastics (Midland, Mich.); those available under the trade designation ELASTHANE from Polymer Technology Group, Inc. (Berkeley, Calif.); and those available under the trade designation TECOTHANE from Thermedics Polymer Products (Wilmington, Mass.).

Additives are frequently added to polyurethanes for a wide variety of reasons including, for example, to improve processing, modify physical and/or chemical properties, modify surface properties, and/or stabilize the polymer to heat and/or light. For example, antioxidants, lubricants, plasticizers, and/or surface modifiers are additives typically encountered in polyurethanes.

Specifically, processing aids are typically added to commercially available polyurethanes to function as one or more of an accelerator, a blowing agent, a compatibilizer, a diluent, a defoaming agent, an exotherm modifier, a lubricant, a nucleating agent, a wetting agent, an antiblocking agent, and/or an antistatic agent. Of particular relevance in the present invention are lubricants.

Lubricants known for use in polyurethanes include, for example, amides, hydrocarbon waxes, fatty acids, fatty acid esters and/or metallic soaps. Amides are particularly useful lubricants for polyurethanes, with an exemplary amide lubricant being N,N′-ethylenebisstearamide (EBS).

For polyurethanes including a lubricant, typically the polyurethane includes at least 0.001% by weight, in certain embodiments at least 0.01% by weight, and in some embodiments at least 0.1% by weight of the additive, based on the total weight of the polyurethane and additive. Such polyurethanes typically include at most 10% by weight, in certain embodiments at most 5% by weight, and in some embodiments at most 1% by weight of the additive, based on the total weight of the polyurethane and additive.

The presently disclosed polyurethane composites include a surface-treated clay. Preferably the clay is a nanoclay. Preferably, the clay has a plate-like structure in which the average thickness of the plates is no greater than 100 nanometers, and more preferably no greater than 10 nanometers. Typically, the spacings between adjacent planes of atoms can be determined by X-ray powder diffraction measurements, in which D₀₀₁ (i.e., the basal spacing) is indicative of plate thickness. For example, montmorillonite clay available under the trade designation CLOISITE NA from Southern Clay Products, Inc. (Gonzales, Tex.) was determined to have a D₀₀₁ of 11.7 Å. Preferably, the ratio of the diameter of a clay plate to its thickness is at least 10, and more preferably at least 100. For clay plates which are not circular in shape, the diameter is taken to be the shortest dimension in the plane of the plate (i.e., a plane that is perpendicular to the thickness dimension). Suitable clays include, for example, montmorillonite clay, Kaolinite clay, and synthetic clays.

The clays used in the presently disclosed composites include surface treated clays. Typically and preferably, the surface of the clay includes an ammonium cation of the formula R¹R²R³R⁴N⁺ wherein each R group independently represents hydrogen or a hydrocarbon moiety. Such ammonium cations of the formula R¹R²R³R⁴N⁺ wherein each R group independently represents hydrogen or a hydrocarbon moiety (and more preferably hydrocarbon moieties) are typically recognized in the art as capable of providing a hydrophobic surface to the clay. In contrast, ammonium cations of the formula R¹R²R³R⁴N⁺ wherein one or more of the R groups contains a polar functionality (e.g., a hydroxy group) are typically recognized in the art as capable of providing a hydrophilic surface to the clay.

In certain embodiments of the present invention, R¹ is hydrogen or methyl; and R², R³, and R⁴ each independently represent a C1-C24 hydrocarbon moiety. In other embodiments of the present invention, R¹ is hydrogen or methyl; R² is methyl; and R³ and R⁴ each independently represent a C1-C24 hydrocarbon moiety. In other certain embodiments of the present invention, R¹ is hydrogen or methyl; R² is methyl; R³ represents a C10-C24 hydrocarbon moiety; and R⁴ represents a C6-C24 hydrocarbon moiety. In even other embodiments of the present invention, R¹ is hydrogen or methyl; R² is methyl; R³ represents hydrogenated tallow; and R⁴ is selected from the group consisting of benzyl, 2-ethylhexyl, hydrogenated tallow, and combinations thereof.

As used herein, the term “hydrocarbon moiety” is used for the purpose of this invention to mean a moiety that is classified as an aliphatic moiety, cyclic moiety, or combination of aliphatic and cyclic moieties (e.g., alkaryl and aralkyl moieties). In the context of the present invention, the term “aliphatic moiety” means a saturated or unsaturated linear or branched hydrocarbon moiety. This term is used to encompass alkyl, alkenyl, and alkynyl moieties, for example. The term “alkyl moiety” means a saturated linear or branched monovalent hydrocarbon moiety including, for example, methyl, ethyl, n-propyl, isopropyl, t-butyl, amyl, heptyl, and the like. The term “alkenyl moiety” means an unsaturated, linear or branched monovalent hydrocarbon moiety with one or more olefinically unsaturated moieties (i.e., carbon-carbon double bonds), such as a vinyl moiety. The term “alkynyl moiety” means an unsaturated, linear or branched monovalent hydrocarbon moiety with one or more carbon-carbon triple bonds. The term “cyclic moiety” means a closed ring hydrocarbon moiety that is classified as an alicyclic moiety or an aromatic moiety. The term “alicyclic moiety” means a cyclic hydrocarbon moiety having properties resembling those of aliphatic moieties. The term “aromatic moiety” means a mono- or polynuclear aromatic hydrocarbon moiety. As a means of simplifying the discussion and the recitation of certain terminology used throughout this application, the term “moiety” is used to indicate a chemical species that does not allow for substitution. Thus, where the term “moiety” is used to describe a chemical compound or substituent, only an unsubstituted chemical material is intended to be included. For example, the phrase “alkyl moiety” is limited to the inclusion of only pure open chain saturated hydrocarbon alkyl substituents, such as methyl, ethyl, propyl, t-butyl, and the like.

Useful surface treated clays include, for example, montmorillonite clay having a surface including the quaternary ammonium cation C₆H₅CH₂(CH₃)₂(HT)N⁺, wherein HT is hydrogenated tallow available under the trade designation CLOISITE 10A; montmorillonite clay having a surface including the ammonium cation (Me)₂(HT)(2-ethylhexyl)N⁺, wherein HT is hydrogenated tallow, is available under the trade designation CLOISITE 25A; montmorillonite clay having a surface including the ammonium cation Me(HT)₂HN⁺, wherein HT is hydrogenated tallow, is available under the trade designation CLOISITE 93A; and montmorillonite clay having a surface including the ammonium cation (Me)₂(HT)₂N⁺, wherein HT is hydrogenated tallow, is available under the trade designations CLOISITE 20A and 15A; all available from Southern Clay Products, Inc. (Gonzales, Tex.).

Surface treated clays recited in the present application are typically prepared by treating the surface of the clay with an ammonium salt of the formula R¹R²R³R⁴N⁺X⁻ wherein R¹, R², R³, and R⁴ are as defined herein above, and X⁻ is an anion such as, for example, a halide, hydrogen sulfate, methyl sulfate, or combinations thereof. Exemplary surface treated montmorillonite clays include: clays having a surface treated with the quaternary ammonium salt C₆H₅CH₂(CH₃)₂(HT)N⁺Cl⁻, wherein HT is hydrogenated tallow, available under the trade designation CLOISITE 10A; clays having a surface treated with the ammonium salt (Me)₂(HT)(2-ethylhexyl)N⁺CH₃OSO₃⁻, wherein HT is hydrogenated tallow, is available under the trade designation CLOISITE 25A; clays having a surface treated with the ammonium salt Me(HT)₂HN⁺HSO₄⁻, wherein HT is hydrogenated tallow, is available under the trade designation CLOISITE 93A; clays having a surface treated with the ammonium salt (Me)₂(HT)₂N⁺Cl⁻, wherein HT is hydrogenated tallow, is available under the trade designations CLOISITE 20A and 15A; all from Southern Clay Products, Inc. (Gonzales, Tex.).

The ammonium salts used for treating the surface of the clay as described herein are typically called intercalants, which can be capable of entering the space between parallel layers of clay plates (i.e., the gallery), and bonding to the surface of the clay, typically via ionic interactions. Thus, the treatment of the surface of the clay with ammonium salts as described herein can lead to intercalation, in which the gallery thickness is increased. Further, the surface of the clay plates can become more compatible with a polymer by proper selection of the ammonium cation (e.g., the proper selection of R¹-R⁴). When the treated clay and polymer are subjected to mixing under certain processing conditions (e.g., shear rate and temperature), the clay plates can be dispersed in the resulting composite. As the thickness of the plates is small, small amounts of clay can generate a large interfacial area and a large number of plates per volume, both of which can be important to provide desired mechanical, barrier, absorption, and other properties of the composite. However, as the amount of clay used is small, other properties of the composite (e.g., optical properties) preferably are not substantially changed. Thus, the use of surface treated nanoclays as described herein to prepare composites can be advantageous compared to traditional micron-sized fillers.

The amount of ammonium salt used to treat the surface of the clay is preferably enough to coat the surface of the plates and ensure efficient intercalation and dispersion, an amount that can vary depending on the nature of the ammonium cation selected. One of skill in the art, in view of the present disclosure, can select appropriate amounts of ammonium salts to treat the surface of the clay through routine experimentation. For example, the amount of treatment agent used for CLOISITE 10A is reported to be from 90-125 meq/100 g clay.

In certain embodiments, the surface treated clay includes at least 30 milliequivalents of ammonium cation per 100 grams of surface treated clay. In certain embodiments, the surface treated clay includes at most 300 milliequivalents of ammonium cation per 100 grams of surface treated clay.

Methods of preparing composites of the present invention preferably include combining at least 0.1 part by weight, more preferably at least 0.5 part by weight, and most preferably at least 1 part by weight surface treated clay with 100 parts by weight of the polyurethane. Such methods preferably include combining at most 20 parts by weight, more preferably at most 10 parts by weight, and most preferably at most 5 parts by weight surface treated clay with 100 parts of the polyurethane. In certain preferred embodiments, combining the surface treated clay with the polyurethane exfoliates the clay.

The presently disclosed composites can be prepared by combining an aromatic polyether-based polyurethane and a surface treated clay by suitable methods including, for example, melt processing (including, for example, twin-screw extrusion), solvent blending, and in situ polymerization (i.e., polymerization in the presence of clay). Preferred methods include extrusion methods, solvent blending, and in situ polymerization.

Medical devices can be fabricated from the presently disclosed composites by suitable methods including, for example, injection molding, extrusion, thermoforming, blow molding, compression molding, coating, casting, and combinations thereof.

The present invention provides polyurethane composites that can adhere to a silicone adhesive, preferably without the need for a separate process to clean the surface of the polyurethane. Preferably, the polyurethane composites can adhere to a room temperature vulcanizable (RTV) one-component acetoxy silicone adhesive (e.g., a medical adhesive). Preferably the composite bonds to a room temperature vulcanizable (RTV) one-component acetoxy silicone adhesive with at least at least 3 pounds per inch (500 N/m) peel force measured by 90 degree peeling at a rate of 0.5 inch per minute (1.3 cm per minute) at room temperature and under dry conditions.

The present invention is illustrated by the following examples. It is to be understood that the particular examples, materials, amounts, and procedures are to be interpreted broadly in accordance with the scope and spirit of the invention as set forth herein.

### EXAMPLES

### Materials

An aromatic polyether-based polyurethane available under the trade designation TECOTHANE (TT-1075D-M) was purchased from NoveOn Inc. (Cleveland, Ohio). TECOTHANE TT-1075D-M has a Durometer (Shore hardness) of 75D. TECOTHANE TT-1075D-M was found to contain approximately 78 atom-% carbon (C) atoms, 17 atom-% oxygen (O) atoms, and 5 atom-% nitrogen (N) atoms. TECOTHANE TT-1075D-M also contains 0.2 wt-% N,N′-ethylenebisstearamide (EBS) as a lubricant. The theoretical atomic composition of EBS is 90 atom-% C atoms, 5 atom-% O atoms, and 5 atom-% N atoms.

Various types of treated and untreated montmorillonite clay available under the trade designation CLOISITE were purchased from Southern Clay Products, Inc. (Gonzales, Tex.).

CLOISITE NA is montmorillonite clay that has not been surface treated with an ammonium salt, but has sodium ions on the surface of the clay, yielding a hydrophilic surface. The layer distance was reported to be 11.7 Angstroms as determined by X-Ray scattering.

CLOISITE 30B is montmorillonite clay that has been surface treated with the ammonium salt Me(2-hydroxyethyl)₂(T)N⁺Cl⁻, wherein T is tallow to give a hydrophilic surface to the clay. The layer distance was reported to be 18.5 Angstroms as determined by X-Ray scattering.

CLOISITE 10A, 25A, 93A, 20A, and 15A are montmorillonite clays that have been surface treated with ammonium salts as described herein above to give hydrophobic surfaces to the clay. The layer distance were reported to be 19.2, 18.6, 23.6, 24.2, and 31.5 Angstroms, respectively, as determined by X-Ray scattering.

An antioxidant available under the trade designation IRGANOX 1076 was purchased from Ciba Specialty Chemicals Inc. (Basel, Switzerland).

A silicone medical adhesive available under the trade designation MED 2000 was purchased from Nusil Technology, Carpinteria, Calif.

### Composite Preparation

Polyurethane was dried down to less than 150 parts per million (ppm) moisture. Clay samples were dried at 100° C. in vacuum overnight. The dried polymer, clay, and about 0.1 wt-% Irganox 1076 were premixed manually, followed by melt-blending with twin-screw extruder (L/D=24, D=25 mm, Haake) operated at 150 revolutions per minute (rpm) and 205° C. melt temperature. The composites were injection molded into straight bar test specimens (3 inches×0.5 inch×0.25 inch) for adhesion test and microtensile specimens as described in ASTM D1708. All the specimens were thermally annealed at 60° C. for 4 hours to release stress concentration.

### Characterization

Surface composition was measured with X-ray photoelectron spectroscopy (XPS).

### Adhesion Tests

Adhesion test samples were made by applying a layer of triacetoxysilane terminated silicone adhesive (MED 2000, Lot number 34896, Nusil Technology, Carpinteria, Calif.) on a straight polyurethane bar test specimen and curing at 50% of relative humidity at 37° C. for 24 hours. A thin stainless steel mesh (0.1 mm thick) was embedded in the adhesive as reinforcement to reduce test variability. Ninety (90) degree peeling tests were performed with an MTS tensile machine (MT 021, MTS Systems Corporation, Eden Prairie, Minn.) at a peeling rate of 2.54 mm/minute. Water contact angle was measured at room temperature.

### Example 1

### Surface Composition of Normal Polymer and Composites

The theoretical bulk atomic composition of the pure polyurethane is 78%, 5%, and 17% (atomic) of carbon, nitrogen, and oxygen, respectively, based on the known chemical structure. The polyurethane also contained 0.2 wt-% of EBS. However, this small amount of additive does not substantially change the theoretical bulk atomic composition of the pure polyurethane. However, the surface composition of this material can be very different. XPS was used to analyze the surface of a specimen that was injection molded and thermally annealed at 60° C. for 4 hours. The results showed that the surface of the specimen had 91.2%, 4.3%, and 4.5% (atomic) carbon, nitrogen, and oxygen, respectively, which is substantially different than the bulk composition. A similar XPS analysis on an EBS sample indicated a surface concentration of 92.2%, 4.0%, and 3.8% (atomic) of C, N, and O, respectively, which was essentially agreed with the theoretical bulk atomic composition of pure EBS, which was 90%, 5%, and 5% (atomic) of C, N, and O, respectively, based on the known chemical structure. Interestingly, the surface composition of the thermally molded polyurethane was closer to that of the theoretical bulk atomic composition of pure EBS than to its own theoretical bulk atomic composition.

The specimens were then cleaned with boiling heptane (98° C.) for 40 seconds in the liquid, followed by 20 seconds in the vapor, and finally a cold heptane quench for 60 seconds. XPS analysis indicated a surface atomic composition of 76%, 5%, and 19% for C, N, and O, respectively, which is similar to the theoretical bulk atomic composition for the polyurethane. The above data indicates that the surface of the processed polyurethane was enriched with EBS.

Six different clay samples were blended into the polyurethane via melt-blending to prepare composites having 2 wt-% clay. The surface compositions of the composite specimens were analyzed using XPS. Carbon, nitrogen, and oxygen were the only elements identified at significant levels in all specimens. The nitrogen content was almost a constant at 4% to 5% (atomic) for all the materials. For convenience, carbon content was used to characterize the surface compositions of all the specimens, because between carbon and oxygen, only carbon or oxygen can be independent.

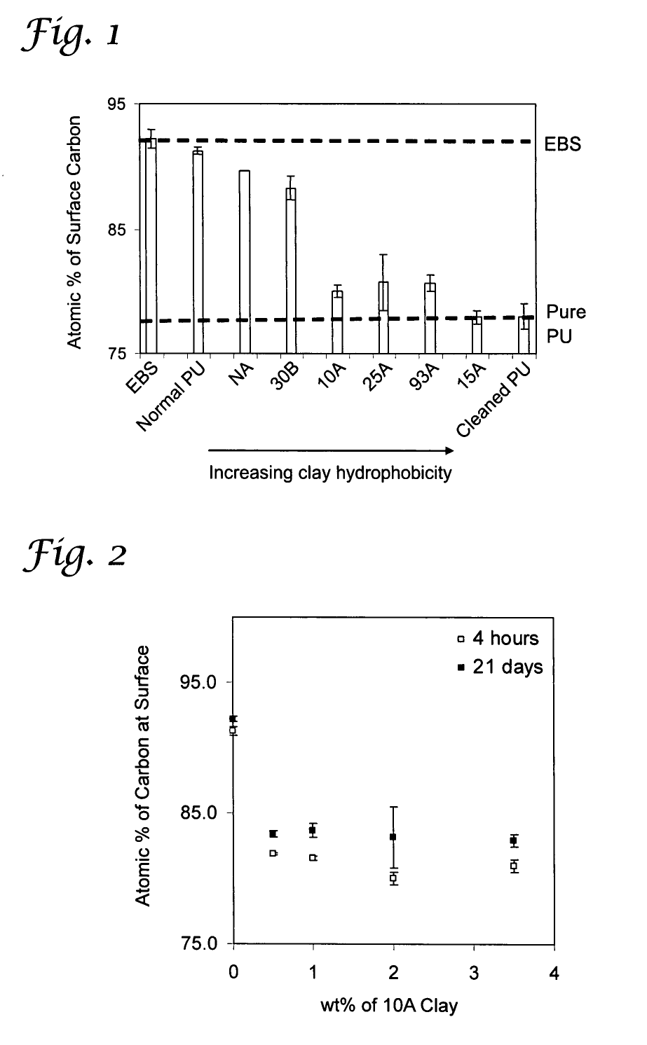

The percent carbon (atomic) measured by XPS on surfaces including bulk N,N′-ethylenebisstearamide (EBS), polyurethane samples measured without and with surface cleaning (Normal PU and Cleaned PU, respectively), and samples of polyurethane composites having 2 wt-% clay for composites prepared using untreated (NA) and various treated montmorillonite clays (e.g., 30B, 10A, 25A, 93A, and 15A, available under the trade designation CLOISITE from Southern Clay Products, Inc., Gonzales, Tex.) were plotted in FIG. 1. The error bars in the figure indicate the standard deviation of 2 to 4 repeats.

The data can be classified into two groups. The surfaces of the composites that had natural clay (NA) and the 30B clay had high carbon content and were similar to that of the uncleaned (or normal) polyurethane or EBS. But, the composites that were had 10A, 25A, 93A, and 15A clays had substantially less carbon in surface and were similar to that of the cleaned (or pure) polyurethane.

As noted herein, clay 10A, 93A, 25A, and 15A, which have been surface treated with various tertiary or quaternary hydrocarbyl ammonium salts, are more hydrophobic than NA and 30B, which are untreated clay (having Na⁺ on the surface) and clay treated with a hydroxyethyl-containing ammonium salt, respectively. The data indicates that the polyurethane composites made using the more hydrophobic clays had percent carbon (atomic) on their surfaces substantially closer to the theoretical bulk atomic composition of the pure polyurethane than the polyurethane composites made using the more hydrophilic clays. The data is consistent with the surfaces of the polyurethane composites made using the more hydrophobic clays having lower concentrations of EBS on their surfaces.

### Example 2

### Surface Composition of Annealed Polymer and Composites

Polyurethane composites having 0.5, 1, 2, and 3.5 wt-% CLOISITE 10A clay were prepared in a manner similar to that described in Example 1. Samples of an unfilled polyurethane (0 wt-%) and samples of the polyurethane composites having 0.5, 1, 2, and 3.5 wt-% CLOISITE 10A clay were annealed at 60° C. for two different time periods: 4 hours and 21 days. The percent carbon (atomic) was measured by XPS as described in Example 1, and the results are plotted in FIG. 2. The error bars in the figure indicate the standard deviation of 2 to 4 repeats.

The results illustrated in FIG. 2 indicate that the surface carbon of all the samples increased very slightly, from 78-80% to 81-83% (atomic). The longer time annealing resulted in higher surface carbon, which is consistent with EBS being enriched on the surface, possibly through migration from the bulk to the surface. However, the surface of all the 10A clay filled composites had percent carbon (atomic) on their surfaces substantially closer to the theoretical bulk atomic composition of the pure polyurethane than bulk EBS.

### Example 3

### Adhesion Improvement by Clay

One of the benefits of the addition of clay to the polyurethanes is that in some embodiments, the adhesion of the polymer to other materials can be improved. A silicone medical adhesive available under the trade designation MED 2000 was applied to the surface the polymers and adhesion was measured by the method described herein above. The silicone adhesive occasionally has variation from lot to lot; however, this variation can be detected based on the adhesion strength with cleaned polyurethane samples. The adhesive used in the present study was tested and the good adhesion was confirmed.

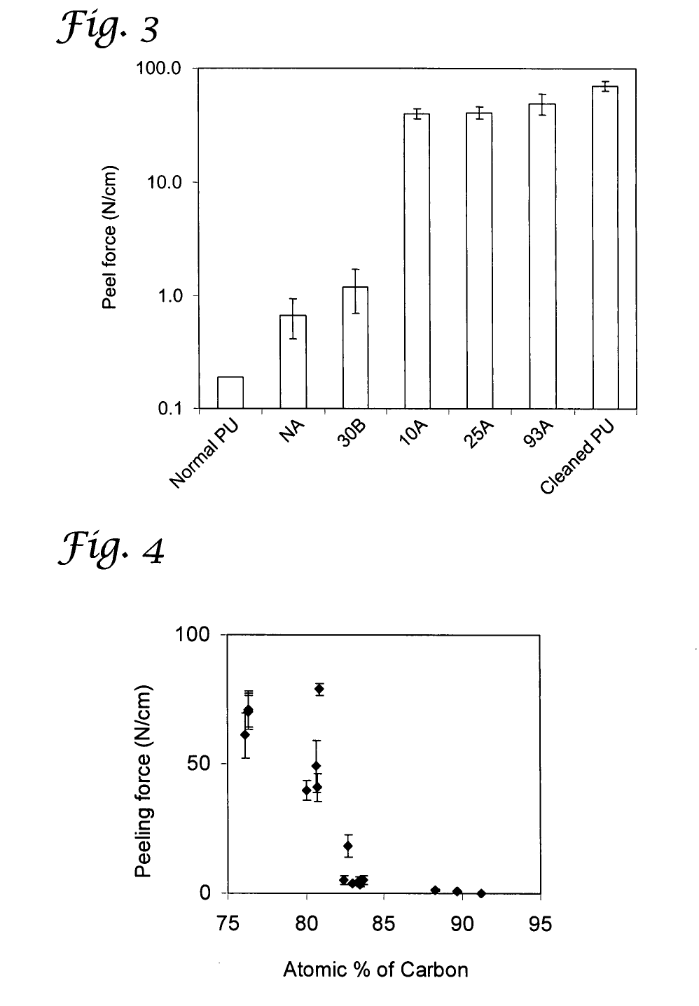

FIG. 3 is a graphical representation of the measured peel force of the silicone medical adhesive to polyurethane samples used without and with surface cleaning (Normal PU and Cleaned PU, respectively), and samples of polyurethane composites having 2 wt-% clay for composites prepared using untreated (NA) and various treated montmorillonite clays (e.g., 30B, 10A, 25A, 93A, available under the trade designation CLOISITE from Southern Clay Products, Inc., Gonzales, Tex.). The error bars in the figure indicate the standard deviation of 4 repeats.

FIG. 4 is a graphical representation of the measured peel force of the silicone medical adhesive to polyurethane samples having varying percent carbon (atomic) surface content as measured by XPS. The samples are the same as those described in FIG. 1 to 3. The surface carbon percentage is the X-axis. The error bars in the figure indicate standard deviation of 4 repeats.

### Example 4

### Water Contact Angle Measurements

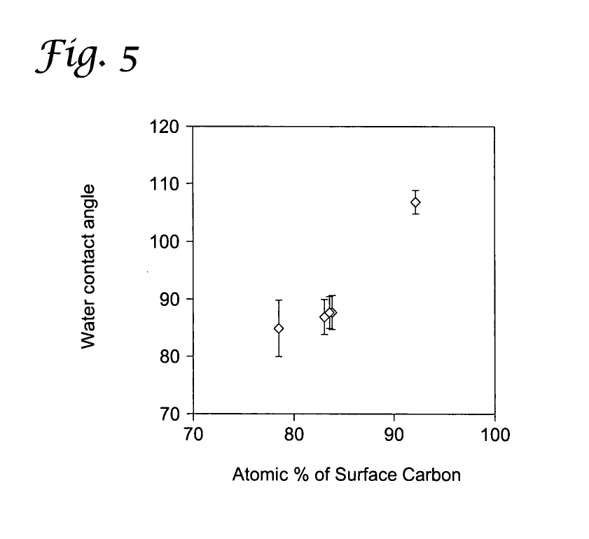

Water contact angles at the surfaces of the polyurethane samples were measured with a Goniometer (Model # A-100, Rame-hart Inc., Mountain Lake, N.J.). The contact angle was automatically read and processed by the instrument. The data were the average of 5 repeats. The samples measured in this example were the polyurethane filled with and without CLOISITE 10A followed by 21 days of annealing. Carbon percentage in FIG. 5 is the X-axis.

FIG. 5 is a graphical representation of the water contact angle for polyurethane samples having varying percent carbon (atomic) surface content as measured by XPS. The plot indicates that the water contact angle is dependent on the percent (atomic) surface carbon, which as illustrated in Example 1, can vary as a function of the type of clay added to make a composite.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. A method of controlling the surface concentration of an additive in a polyurethane, the method comprising:
providing a polyurethane comprising an additive; and
combining a surface treated clay with the polyurethane, wherein the surface of the clay comprises an ammonium cation of the formula:
R¹R²R³R⁴N⁺
wherein each R group independently represents hydrogen or a hydrocarbon moiety.

2. The method of claim 1 wherein the additive comprises a processing aid, a physical property modifier, a chemical property modifier, a surface property modifier, a stabilizer, or a combination thereof.

3. The method of claim 2 wherein the processing aid is selected from the group consisting of accelerators, blowing agents, compatibilizers, diluents, defoaming agents, exotherm modifiers, lubricants, nucleating agents, wetting agents, antiblocking agents, antistatic agents, and combinations thereof.

4. The method of claim 2 wherein the additive is selected from the group consisting of antioxidants, lubricants, plasticizers, surface modifiers, and combinations thereof.

5. The method of claim 4 wherein the lubricant is selected from the group consisting of amides, hydrocarbon waxes, fatty acids, fatty acid esters, metallic soaps, and combinations thereof.

6. The method of claim 5 wherein the amide is N,N′-ethylenebisstearamide.

7. The method of claim 1 wherein the polyurethane comprises at least 0.001% by weight of the additive, based on the total weight of the polyurethane and additive.

8. The method of claim 1 wherein the polyurethane comprises at most 10% by weight of the additive, based on the total weight of the polyurethane and additive.

9. The method of claim 1 wherein the clay is a surface treated nanoclay.

10. The method of claim 9 wherein the clay is a surface treated montmorillonite.

11. The method of claim 1 wherein R¹ is hydrogen or methyl; and R², R³, and R⁴ each independently represent a C1-C24 hydrocarbon moiety.

12. The method of claim 11 wherein R¹ is hydrogen or methyl; R² is methyl; and R³ and R⁴ each independently represent a C1-C24 hydrocarbon moiety.

13. The method of claim 12 wherein R¹ is hydrogen or methyl; R² is methyl; R³ represents a C10-C24 hydrocarbon moiety; and R⁴ represents a C6-C24 hydrocarbon moiety.

14. The method of claim 13 wherein R¹ is hydrogen or methyl; R² is methyl; R³ represents hydrogenated tallow; and R⁴ is selected from the group consisting of benzyl, 2-ethylhexyl, hydrogenated tallow, and combinations thereof.

15. The method of claim 1 wherein the surface treated clay comprises at least 30 milliequivalents of ammonium cation per 100 grams of surface treated clay.

16. The method of claim 1 wherein the surface treated clay comprises at most 300 milliequivalents of ammonium cation per 100 grams of surface treated clay.

17. The method of claim 1 wherein combining a surface treated clay with the polyurethane comprises combining at least 0.1 parts by weight of the surface treated clay with 100 parts by weight of the polyurethane.

18. The method of claim 1 wherein combining a surface treated clay with the polyurethane comprises combining at most 20 parts by weight of the surface treated clay with 100 parts by weight of the polyurethane.

19. The method of claim 1 wherein combining comprises melt processing.

20. The method of claim 19 wherein melt processing comprising extruding.

21. The method of claim 1 wherein combining comprises in situ polymerizing.

22. The method of claim 1 wherein combining comprises solvent blending.

23. The method of claim 1 wherein combining a surface treated clay with the polyurethane exfoliates the clay.

24. A method of preparing a polyurethane for a medical device, the method comprising:
providing a polyurethane comprising an additive; and
dispersing a surface treated clay in the polyurethane, wherein the surface of the clay comprises an ammonium cation of the formula:
R¹R²R³R⁴N⁺
wherein each R group independently represents hydrogen or a hydrocarbon moiety.

25. The method of claim 24 wherein the polyurethane comprises an aromatic polyether-based polyurethane.

26. The method of claim 25 wherein the aromatic polyether-based polyurethane is a thermoplastic polyurethane.

27. The method of claim 25 wherein the aromatic polyether-based polyurethane comprises a unit comprising a product prepared from reacting components comprising methylene diphenyl diisocyanate (MDI) and one or more polyols.

28. The method of claim 27 wherein the one or more polyols comprise a polyether glycol.

29. The method of claim 28 wherein the polyether glycol is polytetramethylene ether glycol (PTMEG).

30. The method of claim 29 wherein the one or more polyols are selected from the group consisting of polytetramethylene ether glycol (PTMEG), 1,4-butanediol, and combinations thereof.

31. The method of claim 24 wherein the polyurethane is a medical grade polyurethane.
